(19) United States
(12) Patent Application Publication
(10) Pub. No.: US 2008/0301141 A1
(43) Pub. Date: Dec. 4, 2008

(54) COMPUTER READABLE MEDIUM AND INFORMATION PROCESSING SYSTEM

(75) Inventor: Yutaka BANJOU, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/056,347

(22) Filed: Mar. 27, 2008

(30) Foreign Application Priority Data
May 30, 2007 (JP) 2007-142727

(51) Int. Cl. G06F 7/04

(52) U.S. Cl. 707/9

(57) ABSTRACT

A computer readable medium storing a program causing a computer to execute a process for managing groups of users, the process includes: storing a group as a set of users and a term of existence of the group, correlating with each other; storing electronic information and an access right of the group to the electronic information, correlating with each other; determining whether or not the term of existence expires; and controlling the access right of the group not to be applied to the users belonging to the group if the term of existence expires.

### CROSS-REFERENCE TO RELATED APPLICATIONS

This application is based on and claims priority under 35 U.S.C. 119 from Japanese Patent Application No. 2007-142727 filed May 30, 2007.

### BACKGROUND

1. Technical Field

The present invention relates to a computer readable medium and an information processing system.

2. Related Art

In the prior art, in the document managing system, it is commonly executed that the user's access should be controlled by setting the access right to the document. Also, it is commonly executed that the setting of the access right should be facilitated by defining the group as a set of users and then setting to the access right to the group.

In case the groups are formed to fit in with the actual organizational structure, the access rights that have already been set to meet the organizational structure must be changed correspondingly when the organization is changed/dissolved because of an organization reform, or the like or the constituent members are changed.

In the prior art, the operations for forming/deleting the group, changing the member, and changing the access right must be carried out to conform to the new organizational structure. Also, in case the groups are formed project by project, a number of groups that have no longer been used occur as the utilization period of time is prolonged.

### SUMMARY

According to an aspect of the present invention, a computer readable medium storing a program causing a computer to execute a process for managing groups of users, the process comprising: storing a group as a set of users and a term of existence of the group, correlating with each other; storing electronic information and an access right of the group to the electronic information, correlating with each other; determining whether or not the term of existence expires; and controlling the access right of the group not to be applied to the users belonging to the group if the term of existence expires.

### BRIEF DESCRIPTION OF THE DRAWINGS

Exemplary embodiment of the present invention will be described in detail based on the following figures, wherein:

FIG. 1 is a conceptual module configurative view of a configurative example of the present embodiment;

FIG. 2 is a conceptual module configurative view of another configurative example of the present embodiment;

FIG. 3 is an explanatory view showing a data configurative example of data that the present embodiment deals with;

FIG. 4 is an explanatory view showing a display example of an accessible time limit;

FIG. 5 is a flowchart showing a calculating/processing example of the accessible time limit;

FIG. 6 is an explanatory view showing a calculating/processing example of a belonging time limit; and

FIG. 7 is a block diagram showing a hardware configurative example of a computer that accomplishes the present embodiment.

### DETAILED DESCRIPTION

An embodiment of the present invention will be explained with reference to the drawings hereinafter.

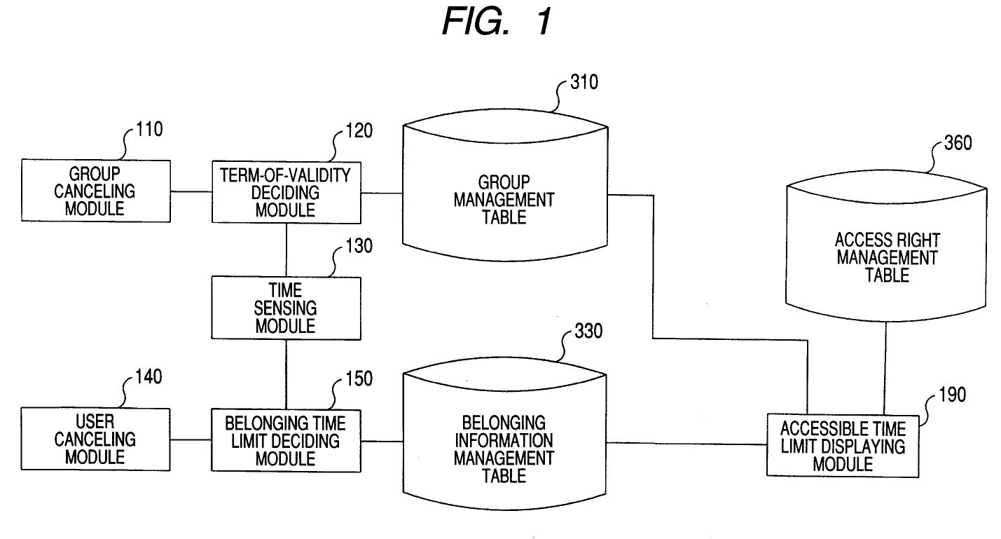

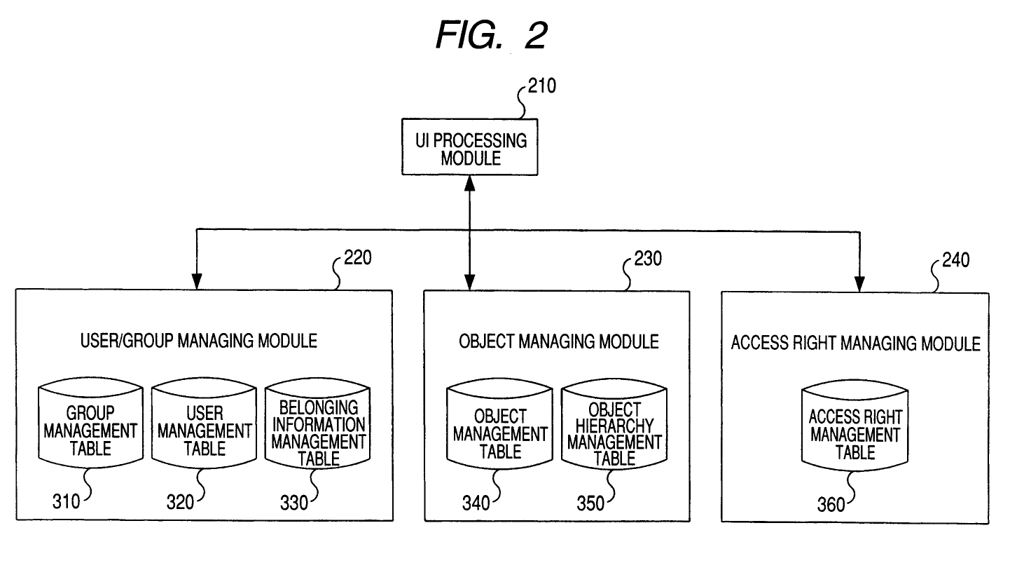

FIG. 1 and FIG. 2 are a conceptual module configurative view of a configurative example of the present embodiment respectively.

Here, commonly the module means the component of software (computer program), hardware, etc. that is logically separable. Therefore, the module in the present embodiment indicates not only the module in the program but also the module in the hardware configuration. For this reason, the explanation of the present embodiment is commonly applied to the program, the system, and the method. In this case, for convenience of explanation, “store”, “cause to store”, and wordings equivalent to them are employed. However, these wordings means “to control to store in the memory” when the embodiment corresponds to the computer program. Also, the module corresponds to the function substantially on a one-to-one basis. In the implementation, one module may be constructed by one program, a plurality of modules may be constructed by one program, or conversely one module may be constructed by a plurality of programs. Also, a plurality of modules may be executed by one computer, or one module may be executed by a plurality of computers in the distributed or parallel environment. Also, in the following explanation, the “connection” contains logical connections (data transfer, instruction, reference between data, and the like) as well as the physical connection.

Also, the system may be constructed by connecting a plurality of computers, hardwares, equipments, or the like via the communication means such as the network (containing the peer-to-peer communication connection), and the like. In addition, the case where the system is constructed by one computer, hardware, equipment, or the like may be contained.

As the object as electronic information that the present invention handles, mainly the document will be explained hereunder. But still image, moving image, sound data, folder, calendar, articles written on the bulletin board, and the like are also contained, and the access right is given to the user or the group.

The “access” means reading or writing of data from or into the storing device (containing the memory, or the like, and not always limited to the storing device in the computer) made by the computer. The access right means the right that is given to the user or the group in handling the object by the computer can.

Normally the user corresponds to a concept of the user who uses the computer and contains the operator, the manager, and the like. The user is managed by the account as an identifier (ID) that can identify uniquely the user. Also, the group is a set of users, and the set has similar roles, purposes, and the like. Like the user, the group is managed by the account that can identify uniquely the group. Also, the user may contain the group in some cases. Also, when the access right is given to the group, the similar access right is given to the users belonging to the group.

As shown in FIG. 1, the present embodiment includes a group canceling module 110, a term-of-validity deciding module 120, a time sensing module 130, a user canceling module 140, a belonging time limit deciding module 150, an accessible time limit displaying module 190, a group management table 310, a belonging information management table 330, and an access right management table 360.

The group canceling module 110, as shown in FIG. 1, is connected to the term-of-validity deciding module 120, and cancels the group when the term-of-validity deciding module 120 decides that the term of validity of the group has expired. The “to cancel the group” means to delete the account of the group. In this case, the account of the user who belongs to the group is not deleted but the access right given to the group is canceled from the user.

The term-of-validity deciding module 120, as shown in FIG. 1, is connected to the group canceling module 110, the time sensing module 130, and the group management table 310. The term-of-validity deciding module 120 decides whether or not a present time sensed by the time sensing module 130 exceeds the term of validity stored in the group management table 310.

The time sensing module 130, as shown in FIG. 1, is connected to the term-of-validity deciding module 120 and the belonging time limit deciding module 150. The time sensing module 130 senses a present time and transfers this sensed time to the term-of-validity deciding module 120 and the belonging time limit deciding module 150. Concretely, the time sensing module 130 reads a time of a clock built in the computer. At this time, the year, month, and day will be explained as the date in the present embodiment, but the date may contain the time, minute, and second. This data can be compared with the term of validity stored in a term-of-validity column 313 of a group management table 310, and the like.

The user canceling module 140, as shown in FIG. 1, is connected to the belonging time limit deciding module 150. The user canceling module 140 cancels the user from the group when the belonging time limit deciding module 150 decides that the time limit has expired. The “to cancel the user from the group” means the group and the user still remain but the user is deleted from the constituent members who belong to the group. The access right given to the group is removed from the user.

The belonging time limit deciding module 150, as shown in FIG. 1, is connected to the user canceling module 140, the time sensing module 130, and the belonging information management table 330. The belonging time limit deciding module 150 decides whether or not a present time sensed by the time sensing module 130 has exceeded the belonging time limit stored in the belonging information management table 330.

The accessible time limit displaying module 190, as shown in FIG. 1, is connected to the group management table 310, the belonging information management table 330, and the access right management table 360. The accessible time limit displaying module 190 selects and displays the time limit being stored by the group management table 310 or the belonging information management table 330 corresponding to the group which is stored in the access right management table 360 and to which the user belongs, as the information about the time limit within which the user belonging to the group that handles the object can access. Also, when information of the access right stored in the access right management table 360 that the groups concerning the object possess is displayed, the accessible time limit displaying module 190 may select and display the time limit stored in the group management table 310 as the information about the accessible time limit. Also, the accessible time limit displaying module 190 may display the information of the access right of the group, which is stored in the access right management table 360 and to which the user belongs, as the information of the access right that is given to the user belonging to the group that handles the object, and also may select and display the time limit stored in the belonging information management table 330 as the information about the accessible time limit.

The group management table 310, as shown in FIG. 1, is connected to the term-of-validity deciding module 120 and the accessible time limit displaying module 190. This group management table 310 stores at least the group and a term of existence of the group to correlate them with each other. This group management table 310 is accessed by the term-of-validity deciding module 120 or the accessible time limit displaying module 190.

The belonging information management table 330, as shown in FIG. 1, is connected to the belonging time limit deciding module 150 and the accessible time limit displaying module 190. This belonging information management table 330 stores at least the group and the time limit within which the user belongs to the group to correlate them with each other. The belonging information management table 330 is accessed by the belonging time limit deciding module 150 and the accessible time limit displaying module 190.

The access right management table 360, as shown in FIG. 1, is connected to the accessible time limit displaying module 190. This access right management table 360 stores at least the object and the access right of the group for the object to correlate them with each other. The access right management table 360 is accessed by the accessible time limit displaying module 190.

The term of validity is set to the group by the group canceling module 110, the term-of-validity deciding module 120, the time sensing module 130, and the group management table 310, and then the term of validity is deleted automatically after expiration of the term of validity. Since the access right of the group still remains within the term of validity as it is, the user can access the document, but the access right is canceled after the expiration of the term of validity.

The term of validity is set to the belonging information of the user to the group by the user canceling module 140, the belonging time limit deciding module 150, the time sensing module 130, and the belonging information management table 330, and then the belong is deleted automatically after expiration of the term of validity. Since the user belongs to the group within the term of validity, the user can access continuously to the document to which the access right is set in the group.

When the document whose access is allowed within a predetermined term is to be displayed on a display screen, the accessible time limit is displayed by the group management table 310, the belonging information management table 330, the access right management table 360, and the accessible time limit displaying module 190.

FIG. 2 shows a conceptual module configurative view of the present embodiment, which is grasped from another aspect.

The present embodiment includes a UI processing module 210, a user/group managing module 220, an object managing module 230, and an access right managing module 240.

As shown in FIG. 2, the UI processing module 210 is connected to the user/group managing module 220, the object managing module 230, and the access right managing module 240. The UI processing module 210 receives the request such as document list display, document acquisition, or the like as the user's operation, and generates/outputs a display screen, or the like. In this case, the sound, and the like are contained in the output.

The user/group managing module 220, as shown in FIG. 2, is connected to the UI processing module 210, the object managing module 230, and the access right managing module 240. The user/group managing module 220 has the group management table 310, a user management table 320, and the belonging information management table 330, and executes user management, group management, member management belonging to the group, and the like.

The object managing module 230, as shown in FIG. 2, is connected to the UI processing module 210, the user/group managing module 220, and the access right managing module 240. The object managing module 230 has an object management table 340 and an object hierarchy management table 350, and manages attribute data of the information (objects such as the document, the folder, etc.) as the object of management and a hierarchical relationship between the folder and the document.

The access right managing module 240, as shown in FIG. 2, is connected to the UI processing module 210, the user/group managing module 220, and the object managing module 230. The access right managing module 240 has the access right management table 360, and manages the access right for the user/group every object.

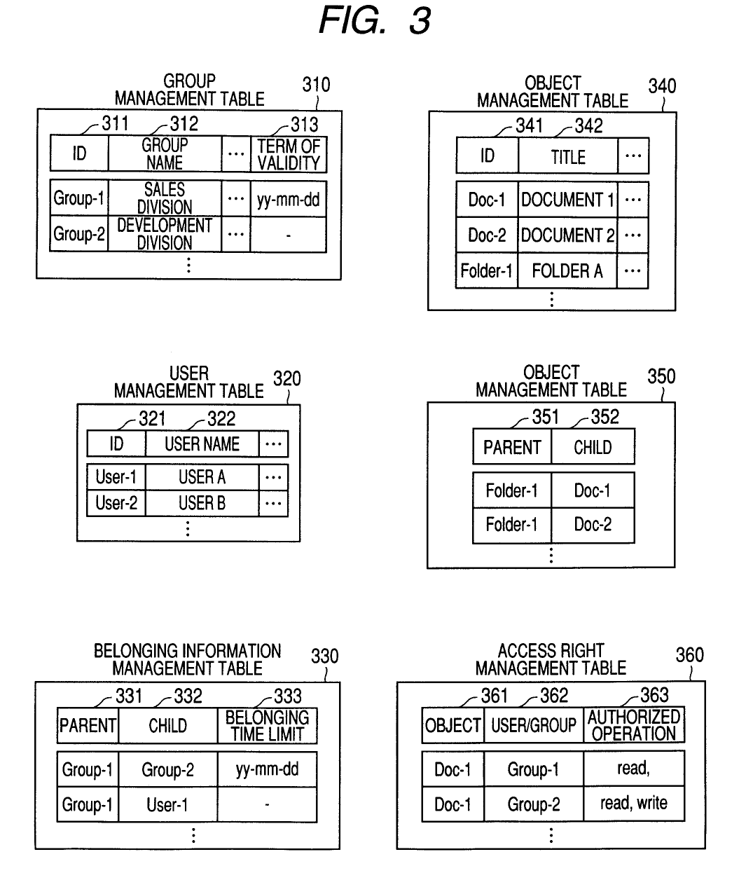

A data configurative example of data that the present embodiment deals with will be explained with reference to FIG. 3. In this case, the data structure cited herein shows an example, and other data structure (e.g., list structure, or the like) may be employed.

The group management table 310 has an ID column 311 for storing the group ID as the account of the group, a group name column 312 for storing the group name as one type of the attribute data, the term-of-validity column 313 for storing the term of validity of the group, and the like. This group management table 310 is used to manage the group ID, attribute data, term of validity, etc.

The user management table 320 has an ID column 321 for storing the user ID as the account of the user, a user name column 322 for storing the user name as one type of attribute data, and the like. This user management table 320 is used to manage the user ID, attribute data, etc.

The belonging information management table 330 has a parent column 331 for storing the group ID as the parent, a child column 332 for storing the IDs (containing the group ID, the user ID, etc.) as the child belonging to the group ID, an belonging time limit column 333 for storing the belonging time limit, and the like in the user/group structure as the hierarchical structure. This belonging information management table 330 is a table that is used to manage belonging information of the group, the term of validity of the belonging. In this example, the belonging information management table 330 manages a belonging relationship of the user group as a paired set of parent and child. Also, in the present data structure, one group can possess a plurality of groups and users as members.

The object management table 340 has an ID column 431 for storing the ID of the object, a title column 342 for storing the title as one type of attribute data of the object, and the like. This object management table 340 is a table that is used to manage the ID of the information (objects such as the document, the folder, etc.) of the object of management, attribute data, and the like.

The object hierarchy management table 350 has a parent column 351 for storing the object ID as the parent of the hierarchical structure, a child column 352 for storing the object ID that is correlated as the child with the object as the parent, and the like in the object hierarchical structure. This object hierarchy management table 350 is a table that is used to manage a hierarchical relationship between the folder and the document as the object of management, and the like.

The access right management table 360 has an object column 361 for storing the object ID, a user/group column 362 for storing the user or group ID to which any access right of the object is given, an authorized operation column 363 for storing the access right that is given to the user or the group, and the like. This access right management table 360 is a table that is used to store and manage the access right information as a three-piece set of the user, the group, and the authorized operation. One object can set the authority to allow the access right to a plurality of users and groups.

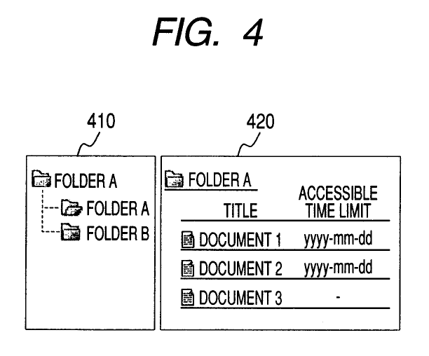

A display example of an accessible time limit that the UI processing module 210 displays on the display device will be explained with reference to FIG. 4.

The UI processing module 210 displays a folder hierarchy display screen 410 and an in-folder document display screen 420 in FIG. 4. The user/group managing module 220 analyzes the hierarchical relation between the folders by using the object hierarchy management table 350 and the object management table 340, and then the UI processing module 210 displays the analyzed result on the folder hierarchy display screen 410. The folder hierarchy display screen 410 in FIG. 4 shows a state that the folder A is selected by the operation of the user. The user/group managing module 220 analyzes the folder hierarchy by using the group management table 310, the user management table 320, the belonging information management table 330, the object management table 340, the object hierarchy management table 350, and the access right management table 360. Then, the UI processing module 210 displays the attribute information (title of the document, accessible time limit to the document) associated with the documents in this folder on the in-folder document display screen 420.

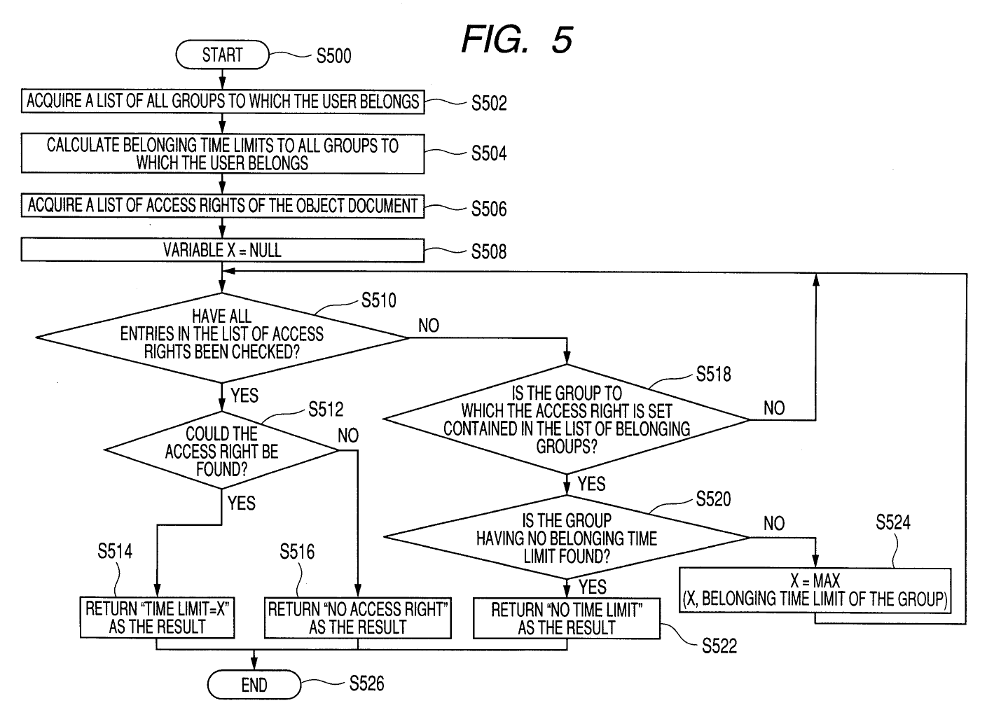

With respect to the document whose access is allowed within a predetermined term, the accessible time limit is also displayed on the in-folder document display screen 420. When the access is allowed without time limit, the accessible time limit is not displayed. Also, the document having no access right to be displayed is not displayed on a list. It is of course that the accessible time limit displayed on the in-folder document display screen 420 is different depending on the user who is operating now. The process concerning the accessible time limit will be explained with reference to FIG. 5 and FIG. 6 hereunder.

A calculating/processing example of the accessible time limit will be explained with reference to FIG. 5 hereunder. This gives a flowchart showing the calculating/processing example of the accessible time limit of some document of some user. The user/group managing module 220, the object managing module 230, and the access right managing module 240 cooperate with each other to execute this process.

In step S502, the user/group managing module 220 acquires a list of all groups to which the user belongs, by using the user management table 320.

In step S504, the user/group managing module 220 calculates belonging time limits to all groups to which the user belongs acquired in step S502 by using the belonging information management table 330. This calculating process will be explained with reference to FIG. 6.

In step S506, the access right managing module 240 acquires a list of access rights of the object document by using the access right management table 360.

In step S508, NULL is substituted into the variable X. Finally, the time limit that is to be displayed as the accessible time limit in the in-folder document display screen 420 is substituted into the variable X.

In step S510, it is decided whether or not all entries in the list of the access rights acquired in step S506 have been checked. The process goes to step S512 if all entries have been checked, while the process goes to step S518 if not so.

In step S518, it is decided whether or not the group as one entry in the list of the access rights acquired in step S506 is contained in the list of all groups to which the user belongs acquired in step S502. If the group is contained (there is at least one access right), the process goes to step S520. In contrast, if the group is not contained, the process goes back to step S510 and then the next entry in the list of the access rights is checked.

In step S520, it is decided by using the belonging information management table 330 whether or not the group decided in step S518 has the belonging time limit. The process goes to step S522 if no belonging time limit is found, while the process goes to step S524 if not so.

In step S522, “no time limit” is returned to the UI processing module 210 as the result because no belonging time limit is found. Then, the UI processing module 210 displays “no time limit” on the accessible time limit in the in-folder document display screen 420.

In step S524, X=max (X, belonging time limit of the group) is calculated because the belonging time limit is found. That is, longer one obtained when the present X is compared with the belonging time limit of the group (longer time period) is substituted into the variable X.

In step S512, it is decided whether or not the user has the access right to the document as the object. This decision is made in response to whether or not the decision “yes” has been made even only once in step S518. The process goes to step S514 if the user has the access right, while the process goes to step S516 if not so.

In step S514, “time limit=X” is returned to the UI processing module 210 as the result because the user has the access right. Then, the UI processing module 210 displays the time limit of X on the accessible time limit in the in-folder document display screen 420.

In step S516, “no access right” is returned to the UI processing module 210 as the result because the user does not have the access right. Then, the UI processing module 210 displays “no access right” on the accessible time limit in the in-folder document display screen 420.

An example of a calculating process of the belonging time limit executed in step S504 shown in FIG. 5 will be explained with reference to FIG. 6 hereunder.

An outline of the present calculating process is given like that the calculating process follows the hierarchy of the belonging groups from the bottom to the top and selects the term of validity of the groups located in the middle and the minimum belonging time limit (shorter time period) out of the group belonging time limits as the belonging time limit.

A group configuration shown in FIG. 6(A) will be explained by way of example. The belonging/hierarchical relation between the user and the group is shown such that User-1 belongs to Group-2 and Group-3, and Group-2 belongs to Group-1.

Suppose that the term of validity of Group-1 is set to no time limit, the belonging time period of Group-2 to Group-1 is set to SdateY, the term of validity of Group-2 is set to YDateZ, the belonging time period of User-1 to Group-2 is set to no time limit, the term of validity of Group-3 is set to no time limit, and the belonging time period of User-1 to Group-3 is set to no time limit.

In this case, the belonging time limit (smaller one out of the term of validity of the group and the time limit belonging to the group) of User-1 to respective belonging groups is given as values in a table in FIG. 6(B) respectively. That is, the belonging time period to Group-1 is given by min (SdateY, YDateZ), and the belonging time period to Group-2 is given by YDateZ, and the belonging time period to Group-3 is given by no time limit.

For example, in the case of the setting in FIG. 6, the accessible time limit to the document as the object of User-1 is given by min (SdateY, YDateZ) when the access right to the document is given only to Group-1 by the flowchart shown in FIG. 5 (step S514), is given by max (min (SdateY, YDateZ)) when the access right to the document is given to Group-1 and Group-2 but the access right is not given to Group-3 (step S514), and is given by no time limit when the access right to the document is given to Group-3 (irrespective of Group-1, Group-2)(step S522).

In this case, when the calculated result in calculating the accessible time limit for the first time is cached every user and then this result is reutilized in calculating the accessible time limit next time, the process in step S504 in FIG. 5 can be sped up.

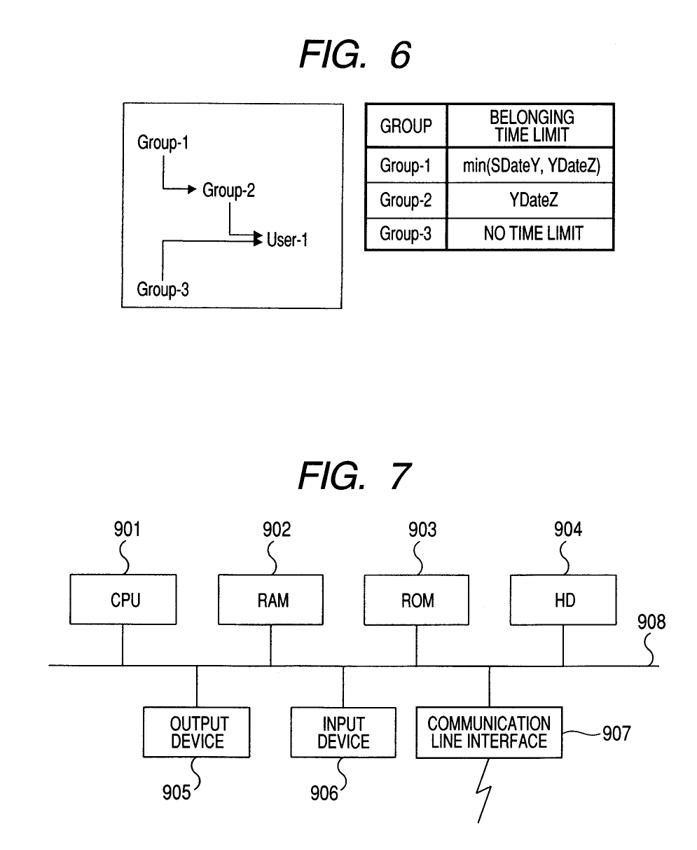

As shown in FIG. 7, a hardware configuration of a computer by which the program as the present embodiment is executed is constructed by an ordinary computer. Concretely, the hardware configuration is constructed by a CPU 901 for executing the programs for the group canceling module 110, the term-of-validity deciding module 120, the user canceling module 140, the belonging time limit deciding module 150, the user/group managing module 220, the object managing module 230, the access right managing module 240, etc.; a RAM 902 for storing the programs and data; a ROM 903 in which the program for starting the present computer, and the like are stored; a HD 904 as an auxiliary memory device (e.g., the hard disk can be used); an input device 906 such as a keyboard, a mouse, etc. for inputting the data; an output device 905 such as the CRT, the liquid crystal display, or the like; a communication line interface 907 for establishing the connection to the communication network (e.g., the network interface card can be used); and a bus 908 for connecting these equipments to transfer the data mutually. Also, a plurality of computers explained above may be connected via the network.

In the present embodiment, the accessible time limit to the user's document is displayed. In this case, a mark (an icon as an image indicating that the accessible time limit is specified), or the like may be attached to the document on the display screen to indicate that the access right is given within the predetermined term. Also, an alarm may be displayed when the user accesses the document whose access is allowed within the predetermined term. In addition, a list of the documents whose access is allowed within the predetermined term respectively may be displayed.

Further, deletion of the group or belonging of the member may be canceled by deleting the time limit information.

Besides, the information to the effect that the time limit is set to the belonging group may transmitted to the member belonging to the group when the term of validity is set to the group. For example, the information may be informed via the mail, the information may be displayed on the display screen, or the like when the user logs in, or the like.

Here, the hardware configuration shown in FIG. 7 shows one configurative example. But the present embodiment is not restricted to the configuration shown in FIG. 7, and any configuration may be employed if such configuration can implement respective modules explained in the present embodiment. For example, a part of modules may be constructed by a dedicated hardware (e.g., ASIC, or the like). Also, the present embodiment may be incorporated into the cellular phone, the game machine, the car navigation system, the information home appliances, the copying machine, the facsimile, the scanner, the printer, the composite machine (the image processing equipment that is also called the multifunction copying machine and has two functions or more of the scanner, the printer, the copying machine, the facsimile, etc.), and the like, in addition to the personal computer.

The program explained above may be stored in the recording medium and then provided. Also, this program may be provided via the communicating means. In such case, for example, the program explained above can be grasped as the invention of the “computer-readable recording medium for recording the program”.

The “computer-readable recording medium for recording the program” means the computer-readable recording medium that records the program and is used to install, run, distribute, and the like the program.

As the recording medium, for example, digital versatile disc (DVD) such as “DVD-R, DVD-RW, DVD-RAM, etc.” as the standard decided in the DVD forum, “DVD+R, DVD+RW, etc.” as the standard decided in the DVD+RW, and the like, compact disk (CD) such as the compact disc read only memory (CD-ROM), the compact disc-recordable (CD-R) the compact disc-rewritable (CD-RW), and the like, magneto-optics disc (MO), flexible disk (FD), magnetic tape, hard disk, read only memory (ROM), electrically erasable and programmable read only memory (EEPROM), flash memory, random access memory (RAM), and others are contained.

Also, the above program or a part of the program may be recorded in the recording medium to save, distribute, and the like. Also, the program may be transmitted by the communication via the transmission medium, for example, the cable network such as local area network (LAN), metropolitan area network (MAN), wide area network (WAN), Internet, intranet, extranet, or the like, the radio communication network, and their combination. Also, the program may be carried via the carrier wave.

In addition, the above program may be constructed as a part of other program, or may be recorded on the recording medium together with other programs. Also, the above program may be split and recorded on plural recording media.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A computer readable medium storing a program causing a computer to execute a process for managing groups of users, the process comprising:
storing a group as a set of users and a term of existence of the group, correlating with each other;
storing electronic information and an access right of the group to the electronic information, correlating with each other;
determining whether or not the term of existence expires; and
controlling the access right of the group not to be applied to the users belonging to the group if the term of existence expires.

2. A computer readable medium storing a program causing a computer to execute a process for managing groups of users, the process comprising:
storing a group as a set of users and a time limit for a user of the group to belong to the group, correlating with each other;
storing electronic information and an access right of the group to the electronic information, correlating with each other;
determining whether or not the time limit expires; and
if the time limit for the user expires, deleting the user from the group.

3. The computer readable medium as claimed in claim 1, further comprising:
calculating a time limit for the user to access the stored electronic information based on the access right correlated with the stored electronic information; and
displaying the stored electronic information and the calculated time limit, correlating with each other.

4. The computer readable medium as claimed in claim 2, further comprising:
calculating a time limit for the user to access the stored electronic information based on the access right correlated with the stored electronic information; and
displaying the stored electronic information and the calculated time limit, correlating with each other.

5. An information processing system comprising:
a group storage that stores a group as a set of users and a term of existence of the group, correlating with each other;
an access right storage that stores electronic information and an access right of the group to the electronic information, correlating with each other;
a determining unit that determines whether or not the term of existence expires; and
a controlling unit that controls, if the term of existence expires, the access right of the group not to be applied to the users belonging to the group.

6. An information processing system comprising:
a group storage that stores a group as a set of users and a time limit for a user of the group to belong to the group, correlating with each other;
an access right storage that stores electronic information and an access right of the group to the electronic information, correlating with each other;
a determining unit that determines whether or not the time limit expires; and
a deleting unit that, if the time limit for the user is determined to expire, deletes the user from the group.
